(19) United States
(12) Patent Application Publication
(10) Pub. No.: US 2019/0279526 A1
(43) Pub. Date: Sep. 12, 2019

(54) LANGUAGE LEARNING DEVICE AND METHOD FOR USE THEREOF

(71) Applicant: Abrham Yidenk Abrha, Everett, WA (US)

(72) Inventor: Abrham Yidenk Abrha, Everett, WA (US)

(21) Appl. No.: 16/293,501

(22) Filed: Mar. 5, 2019

Related U.S. Application Data
(60) Provisional application No. 62/640,533, filed on Mar. 8, 2018.

(51) Int. Cl. G09B 19/06; G09B 5/06

(52) U.S. Cl. CPC G09B 19/06; G09B 5/06

(57) ABSTRACT

A language learning device is provided. The language learning device includes a housing with data storage and a processor. A first set of keys is positioned on a front surface of the housing and each key represents a sub-letter of a language. A second set of keys is positioned on the front surface of the housing and each key represents a main letter of the language. A display is provided on the front surface of the housing to display a graphical representation of a letter identified by selection of one of the keys from the first set and one of the keys from the second set.

### CROSS-REFERENCE TO RELATED APPLICATION

This non-provisional patent application claims priority under 35 U.S.C. § 119(e) to U.S. Provisional Patent application, Ser. No. 62/640,533, filed Mar. 8, 2018, the disclosure of which is incorporated by reference.

### FIELD

The present invention relates in general to learning devices and, in particular, to a language learning device and method for use thereof.

### BACKGROUND

Amharic is a language spoken by tens of millions of people in Ethiopia, as well as other countries. The Amharic language (alphanumeric) can be taught with the help of Fidel, which is a small piece of animal hide, paper or poster where the Amharic Language alphabets, letters and numbers are printed. There is an extremely large number of letters in the Amharic language compared with other languages, such as English. Most Fidels of the Amharic language include 231 commonly used letters and 1000 Ge'ez numerals. Additionally, some Fidels may include an additional 38 lesser used letters.

The large number of letters in the alphabet can make learning the Amharic language difficult. A display of the language can allow learners to reference the letters; however, additional support is needed to facilitate learning by teaching letter recognition and phonetics. In the English language, there are 26 letters, which can easily fit on a tablet or phone screen, as well as on toy-like devices and the Speak and Spell toy by Texas Instruments. However, providing the commonly used 231 letters on an Amharic language learning device to facilitate teaching is extremely difficult due to size constraints of the learning device. For example, if each letter was assigned a separate button or key, the language learning device would need to be extremely large to accommodate such a large number of buttons and thus, would not be practical to hold, carry, or use.

Accordingly, a system and method for building and using an appropriately sized language learning device with all, or at least the most common, letters for the Amharic language is needed. Preferably, the device includes a minimal amount of buttons for displaying and playing the sound for the letters by combining buttons to represent letters in the alphabet and generate a sound for those letters.

### SUMMARY

The Amharic E-Fidel learning device is a teaching tool for the Amharic language alphabet, letters and numbers. The Amharic E-Fidel transforms the ancient way of teaching the language's alphanumeric characters to an electronic form. The device includes three set of keys. The first group of keys includes six keys and the second group of keys include 33 main letters or consonants. The first set of keys each represent a letter and sound for a total of 33 letters. Further, the first and second sets of keys can be combined to provide 198 extension or sub letters (vowels). For example, each of the six keys are activated by pressing one of the 33 main letter keys from the second set of keys. Thus, the combinations formed by selecting each key from the first set and each key from the second set represent 198 different letters for which a graphical representation and sound can be provided via the language learning device. Accordingly, the device can provide 231 of the most commonly used letters in the Amharic language with only 39 buttons. The third group of keys includes twenty consecutive number keys for 1, 2, 3, 4, 5, 6, 7, 8, 9, 10, 20, 30, 40, 50, 60, 70, 80, 90, 100 and 1000.

A language learning device is provided. The language learning device includes a housing with data storage and a processor. A first set of keys is positioned on a front surface of the housing and each key represents a sub-letter of a language. A second set of keys is positioned on the front surface of the housing and each key represents a main letter of the language. A display is provided on the front surface of the housing to display a graphical representation of a letter identified by selection of one of the keys from the first set and one of the keys from the second set.

Still other embodiments will become readily apparent to those skilled in the art from the following detailed description, wherein are described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a front view showing, by way of example, a language learning device.

FIG. 2 is a back view showing, by way of example, the language learning device of FIG. 1.

FIG. 3 is a block diagram showing, by way of example, an electric circuit path for the language learning device of FIG. 1.

FIG. 4 is a block diagram showing, by way of example, keys for sub-letters.

FIG. 5 is a block diagram showing, by way of example, keys for main letters.

FIG. 6 is a block diagram showing, by way of example, a combination of a main letter HA with each of the sub-letters of FIG. 4.

FIG. 7 is a block diagram showing, by way of example, a combination of a main letter LE' with each of the sub-letters of FIG. 4.

FIGS. 8-38 show different letters formed from different combinations of a main letter from FIG. 5 and a sub-letter from FIG. 4.

FIG. 39 is front view of the language learning device of FIG. 1 with a graphical representation of a letter and written sound.

FIG. 40 is a block diagram showing, by way of example, keys for numbers.

FIG. 41 is front view of the language learning device of FIG. 1 with a graphical representation of a number of FIG. 40.

### DETAILED DESCRIPTION

Any language can be difficult to learn, whether the language is a first or subsequent language. However, some languages can be harder to learn than others, such as based on a number of letters in the alphabet and pronunciation of the letters. Some languages, such as Amharic, have many more letters than other languages, such as English. Accordingly, making language learning devices can be difficult due to the amount of letters and sounds that must be included on a device to facilitate learning. For example, the Amharic language includes 231 common letters and thus, fitting all 231 on a language device requires an extremely large device or extremely small keys representing the letters. An Amharic e-fidel language learning device can include a reduced number of keys, while representing the common letters and sounds using combinations of keys to identify the letters and play the corresponding sounds.

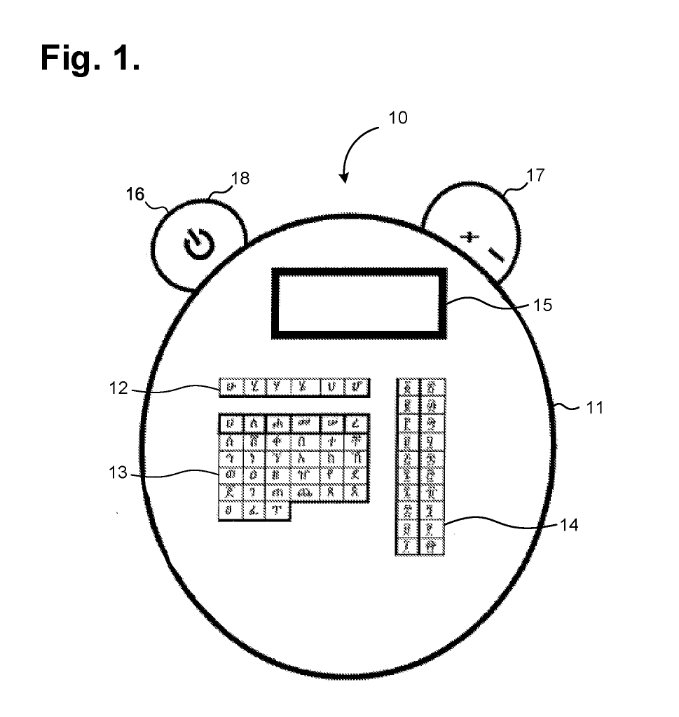

The language learning device provides letters and sounds, which can be accessed via a combination of keys to assist learners of a language via letter and number recognition, and phonetics. FIG. 1 is a front view showing, by way of example, a language learning device 10. The language learning device 10 can include a housing 11 made of plastic, metal, rubber, silicone, and alloys, as well as other materials. The housing 11 can have a particular shape, such as circular, square, or rectangular, and can include input controls 12-14, such as keys or touch buttons, as well as a display 15. In one embodiment, the housing can have a circular shape. Other shapes of the housing and types of input controls are possible.

The language learning device 10 can include multiple sets of keys, such as on a front surface of the housing 11. The key sets can include one set of six keys 12, one set of 33 keys 13, and one set of 20 keys 14. However, other numbers of key sets and numbers of keys are possible and can be dependent on the language to be learned via the language learning device. In one embodiment, the first set of buttons 12 can be displayed underneath the display 15 and the second set of buttons 13 can be displayed underneath the first set of buttons 12, while the third set of buttons 14 is displayed to a right of the first 12 and second 13 sets of buttons. However, the button sets 12-14 can be displayed in different areas on the language learning device 10. The terms keys and buttons are used interchangeably.

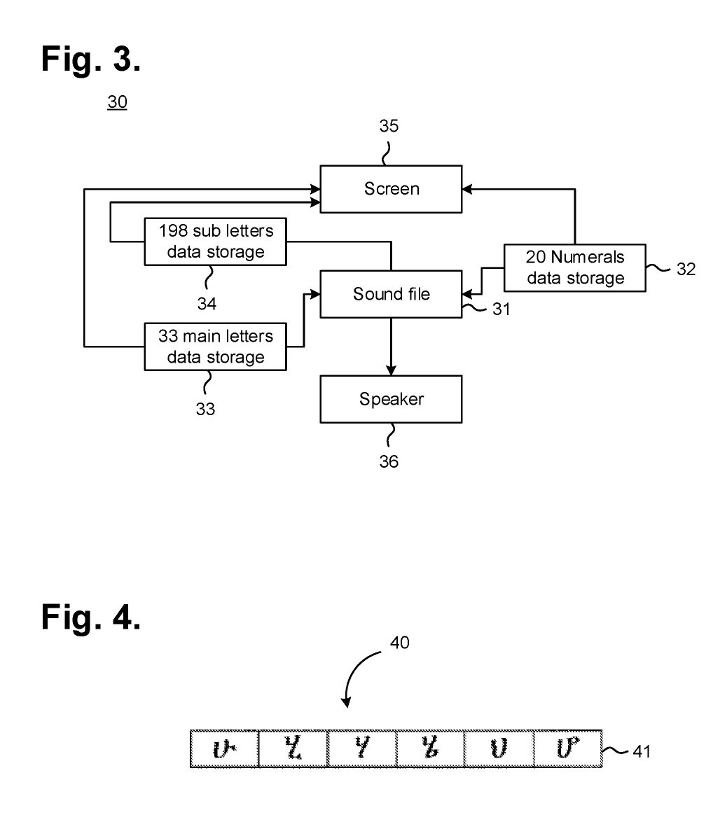

In the 33 key set 13, each key represents one of 33 main letter keys, which are consonants of the Amharic language and each of the six keys in the other set 12 can represent extension or sub-letters, such as vowels, of the main letter keys. Each consonant can be combined with one of the sub-letters to represent a different letter based on a consonant-vowel pair that is associated with a graphical representation and sound. Each of the 33 main letter individually are associated with a sound, while the six sub-letters are combined with each of the 33 main letters to represent a letter and sound for the letter. The combinations of the main letters and sub-letters represent 198 extension letters and corresponding sounds. The 20 key set can include the numbers 1, 2, 3, 4, 5, 6, 7, 8, 9, 10, 20, 30, 40, 50, 60, 70, 80, 90, 100 and 1000. Other numbers of input sets and letter keys are possible. Each of the keys are associated with a sound that when pressed can be played, as further described below with referenced to FIG. 3.

The housing 11 of the language learning device 10 can also include the display 15, a power button 16 for turning the device on and off, and a volume control 17 for increasing or decreasing a volume of the device 10. In one embodiment, each of the power button 16 and volume control 17 can be provided on an extension to the housing, rather than on the housing itself. For example, the power button 16 can be provided on an extension 18 to the housing 11 and the volume control 17 can be located on a separate extension to the housing 11. The extensions 18 can have the same shape or a different shape than the housing 11 and can be made from the same or different materials than the housing 11. In one embodiment, each of the extensions can be formed as partial circles that extend from the housing, which can have a circular shape.

The display 15 displays the letter associated with one or more keys on the device and optionally, a phonetic transcription of the letter in English or another language. Additionally, for numbers, Ge′ez numerals can be displayed, along with the phonetic transcription, English word for the number, and Arabic number. Other types of information for each letter or number can also be displayed.

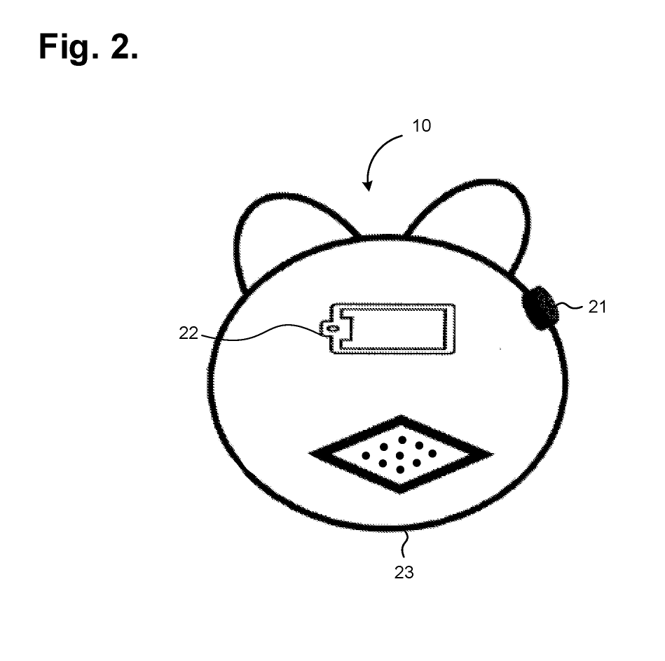

FIG. 2 is a back view showing, by way of example, the language learning device of FIG. 1. A battery receptacle 22 and a speaker 23 can be provided on a back side of the language learning device 10. A headphone plugin 21 can also be provided on the back side of the device 10. Alternatively, each of the headphone plugin 21, battery receptacle 22, and speaker 23 can be provided on the front side of the device, or on an outer edge of the device 10, located between the front and back sides. The battery receptacle 22 can house the batteries required to power the device 10, while one or more speakers 23 can be provided on the device 10 to play the phonetic sounds associated with a displayed letter.

FIG. 3 is a block diagram showing, by way of example, an electric circuit path 30 for the language learning device of FIG. 1. Data for each of the three different sets of keys can be stored separately or together in memory on the device or in a separately located database. Such memory can include RAM, and non-volatile memory, such as flash memory. When stored separately, alphanumeric graphical representation data can be stored for the 33 main letters 33, the 20 numerals 32, and a combination of each of the six sub-letters with each of the 33 main letters, for a total of 198 extension letters 34. Specifically, the six key set is associated with 198 different alphanumeric data displays and phenomes or sounds for 198 extension letters, which are activated by pressing each of the main letter keys with each of the sub-letter keys. Different numbers of keys and letters are possible for different languages.

Canned or prerecorded sounds can be stored as sound files 31 separately from the alphanumeric graphical representation data or together with the alphanumeric graphical representation data. In one embodiment, the sounds can be stored in separate files for each set of letters or numbers, or all the sounds can be stored in a single file.

Upon selection of each key of the 33 main letters and the 20 numerals, an electronics signal is transmitted to the alphanumeric electronic storage 32-34 and to the sound file 31 for respectively releasing the alphanumeric graphical representation data to a display 35 on the language learning device and the respective sound of the displayed letter or number to a speaker 36 on the language learning device. Specifically, by pressing buttons for a main letter and a sub-letter, a processor located within the language learning device accesses, a graphical representation of an extension letter represented by the main letter and sub-letter combination from the sub-letter data storage 34 with 198 representations for display. The buttons can be pressed simultaneously or one prior to another.

Further, the processor can access the sound file associated with the letter represented by the main letter and sub-letter combination for playing via the speaker. The processor can be a micro-controller, which can include a central processing unit (not shown) capable of executing computer-executable code.

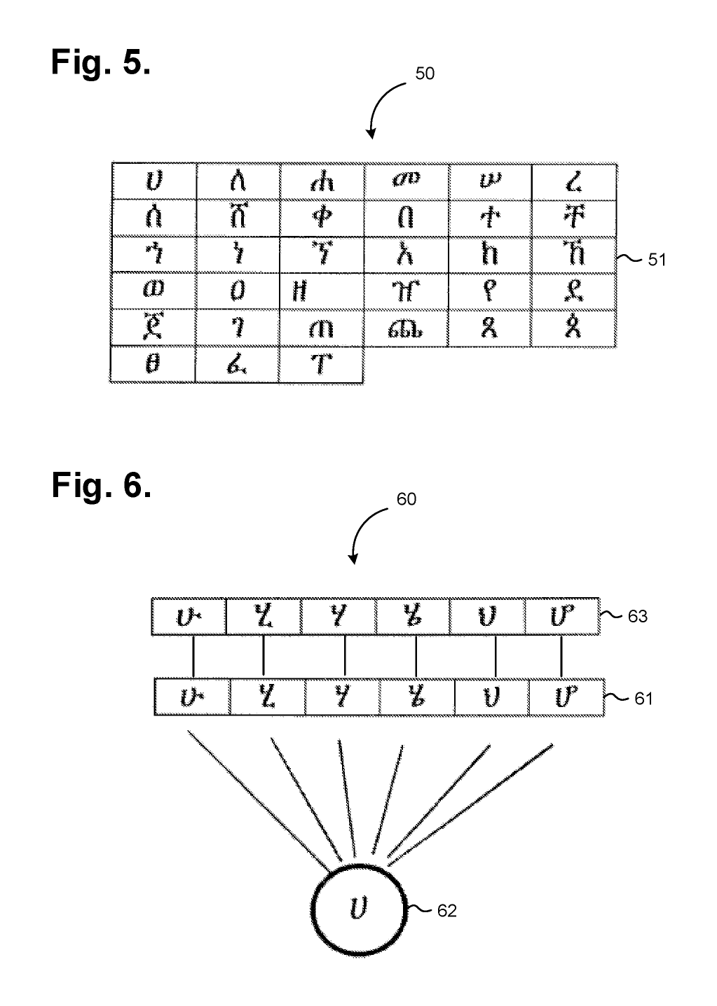

The six sub-letters are each combined with each of the 33 main letters to form 198 different letters. FIG. 4 is a block diagram showing, by way of example, keys for each of the six sub-letters 41 in a set 40. Specifically, the sub-letters 41 each include a vowel in the Amharic language that is combined with a constant represented by one of the main letters to play a sound and display the corresponding letter, as discussed below with respect to FIG. 5.

FIG. 5 is a block diagram showing, by way of example, keys for the main letters 51 in a set 50. Each of the main letters 51 represents a consonant in the Amharic language that is associated with a sound and a graphic representation of the letter. Further, each of the main letters can be combined with a sub-letter to form a different sound and a different graphic representation of the letter represented by the combination of the main letter and sub-letter.

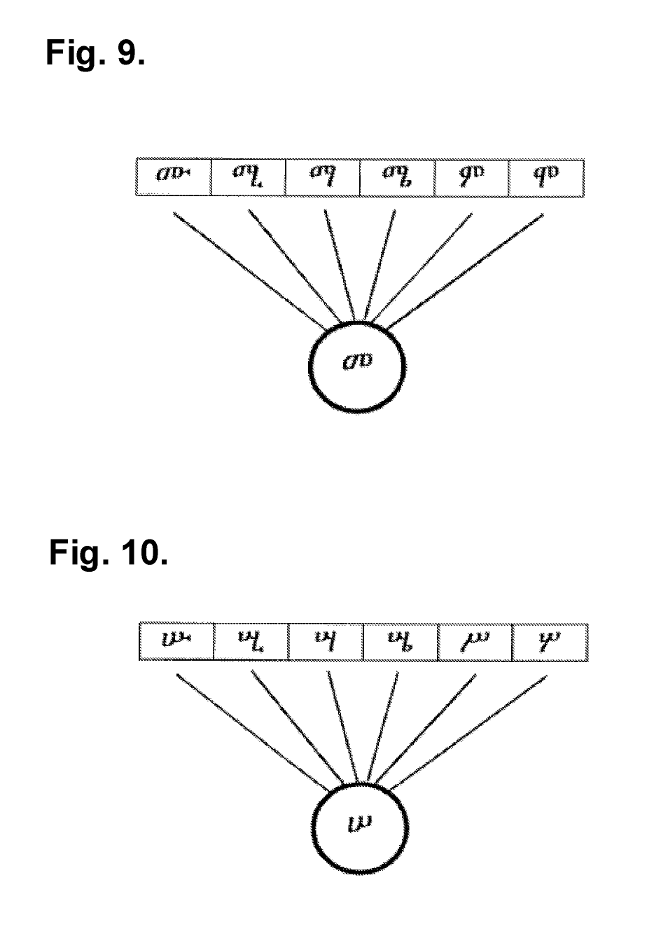

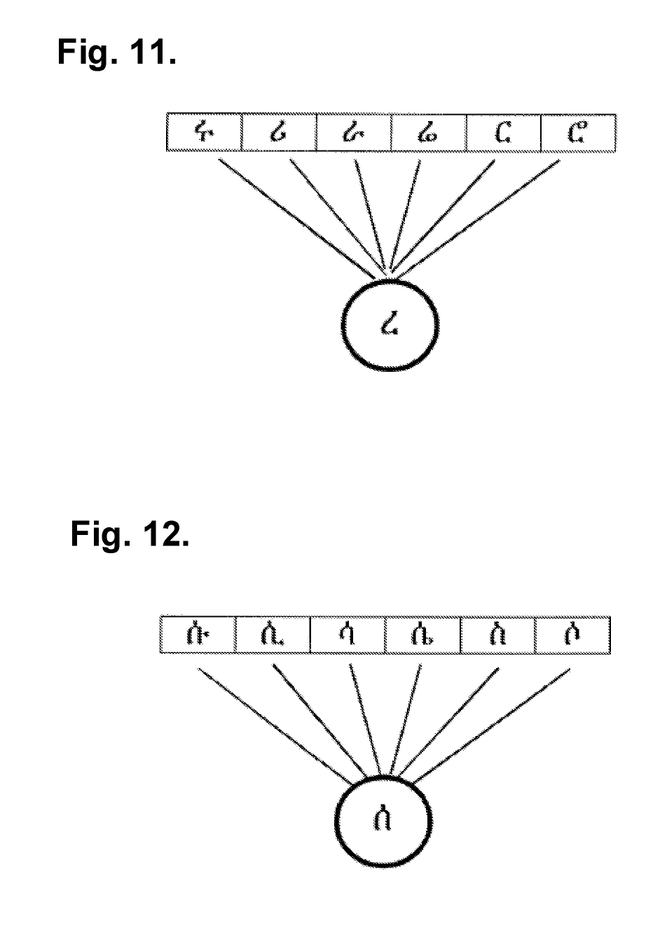

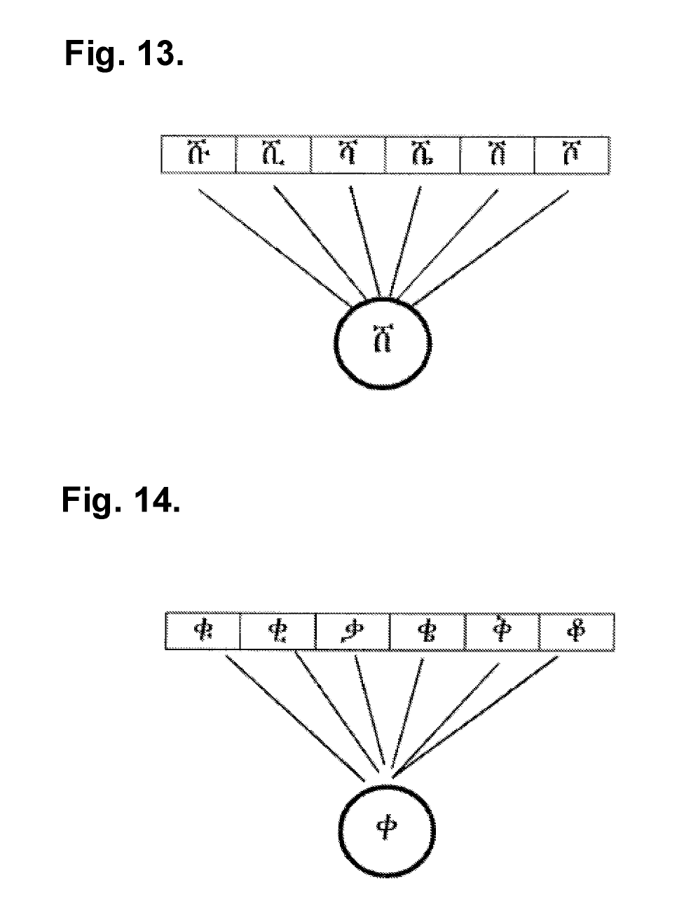

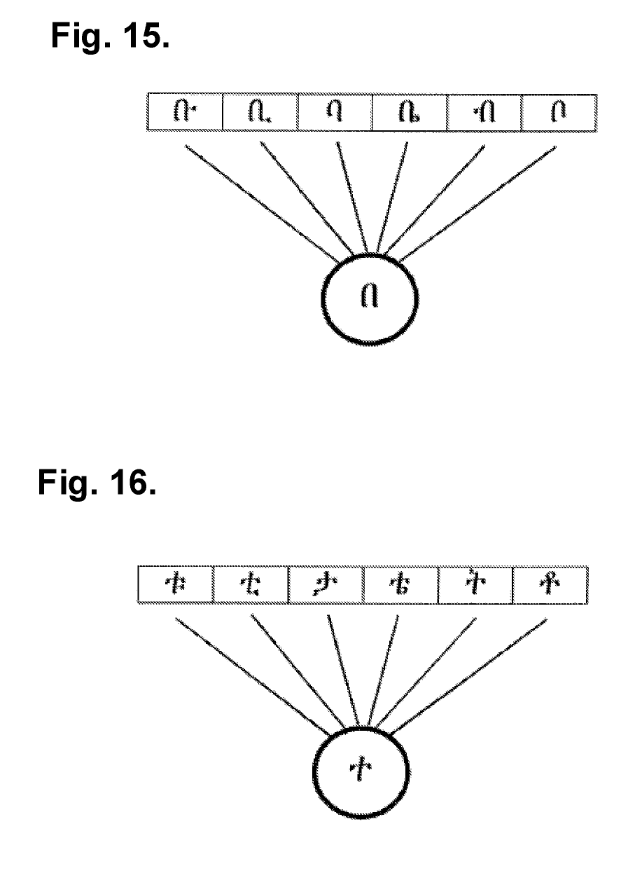

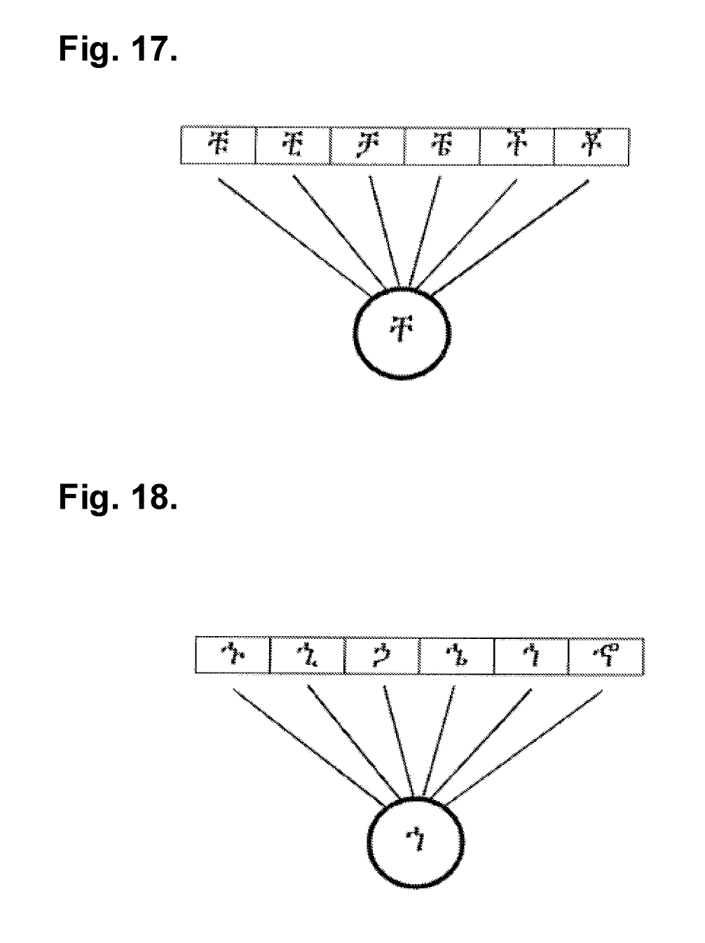

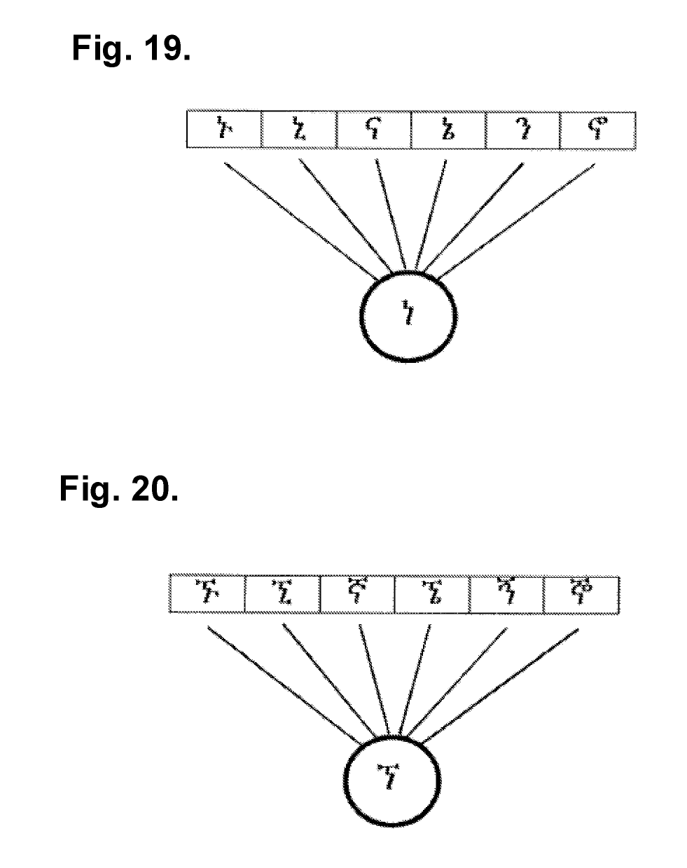

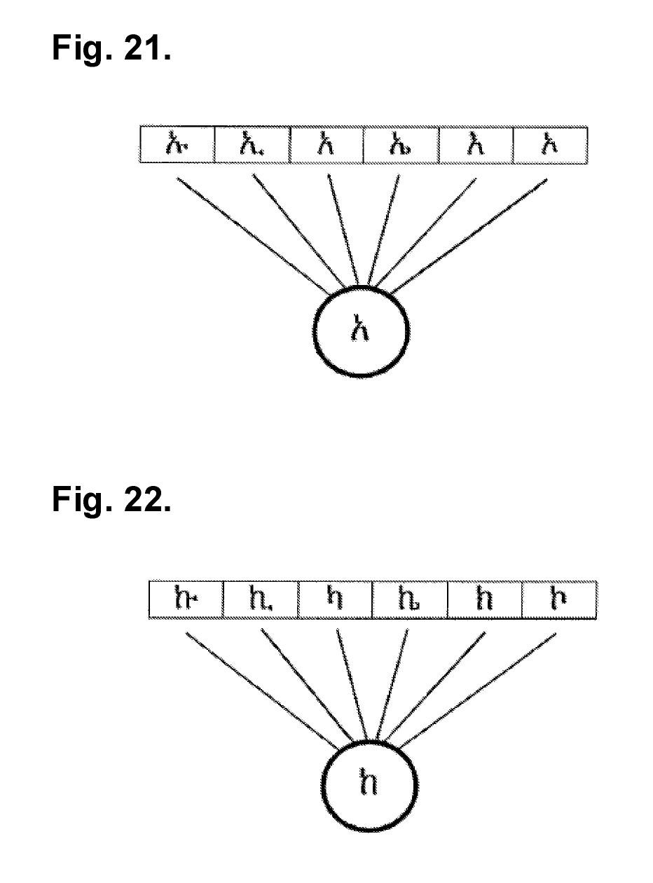

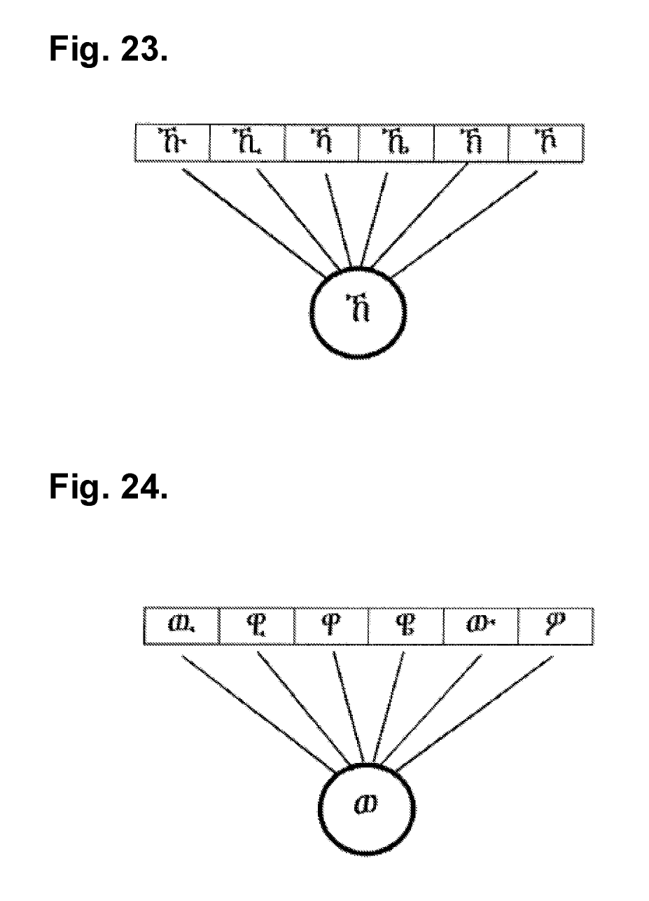

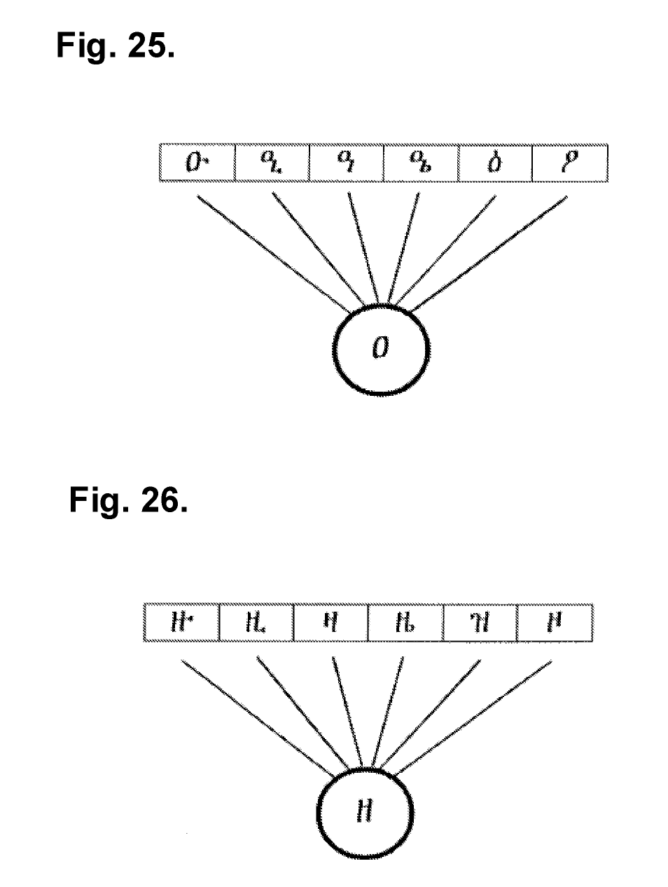

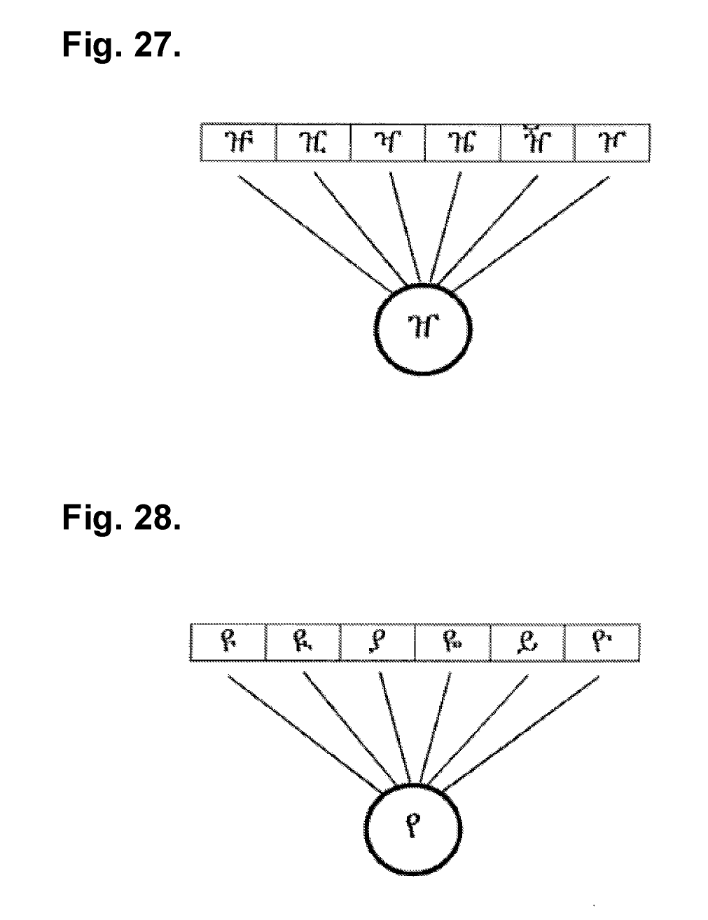

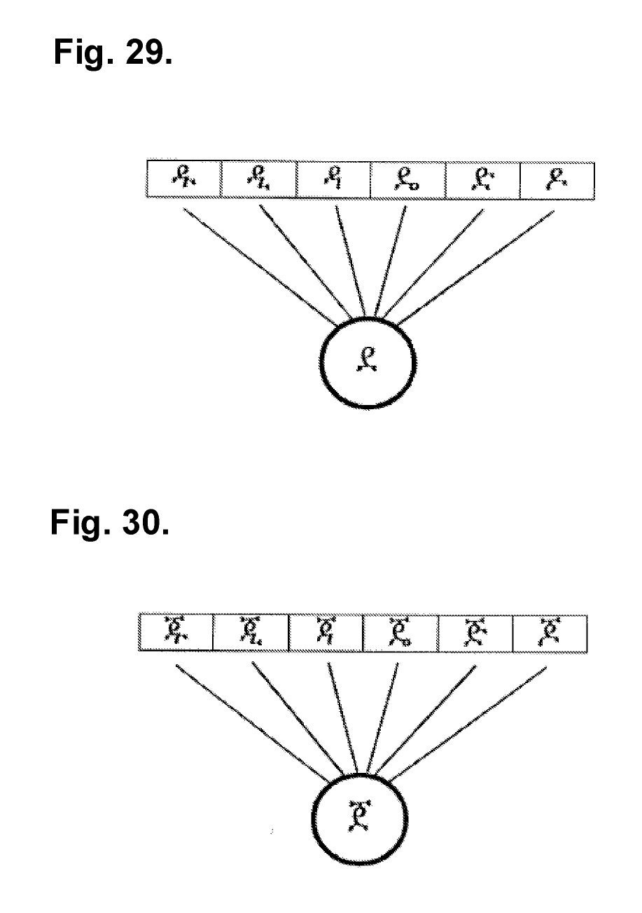

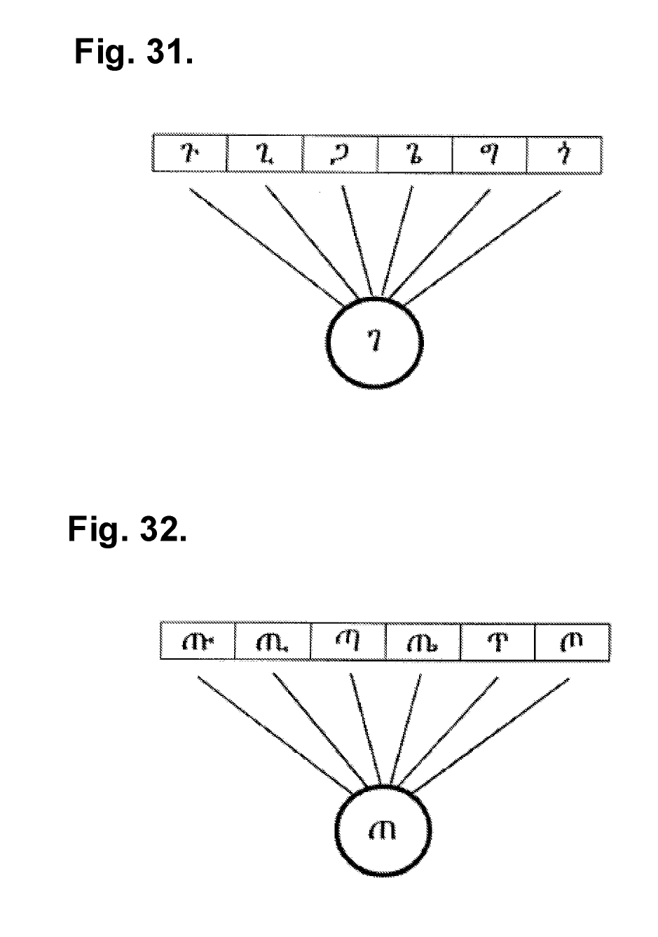

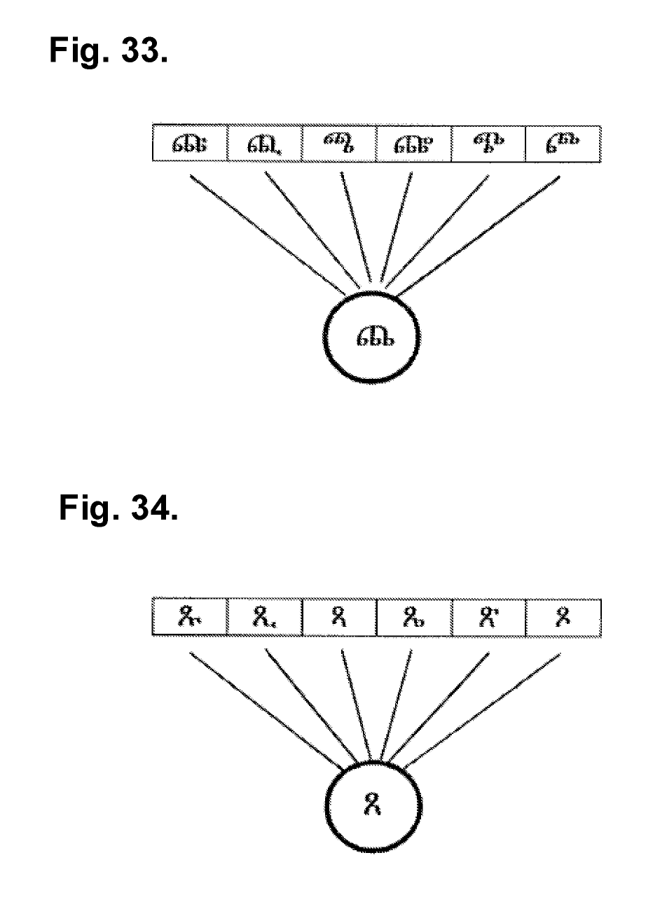

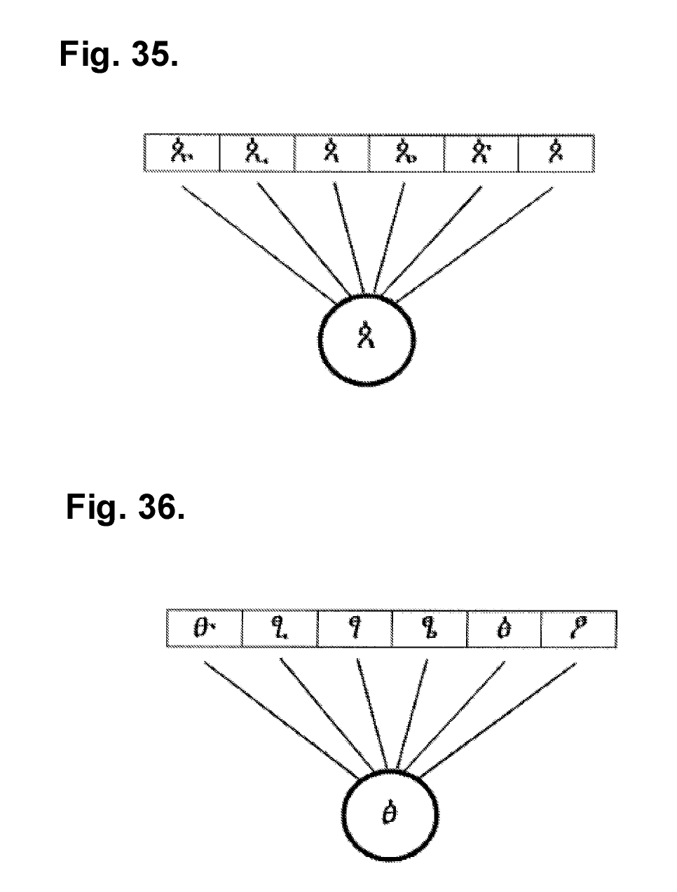

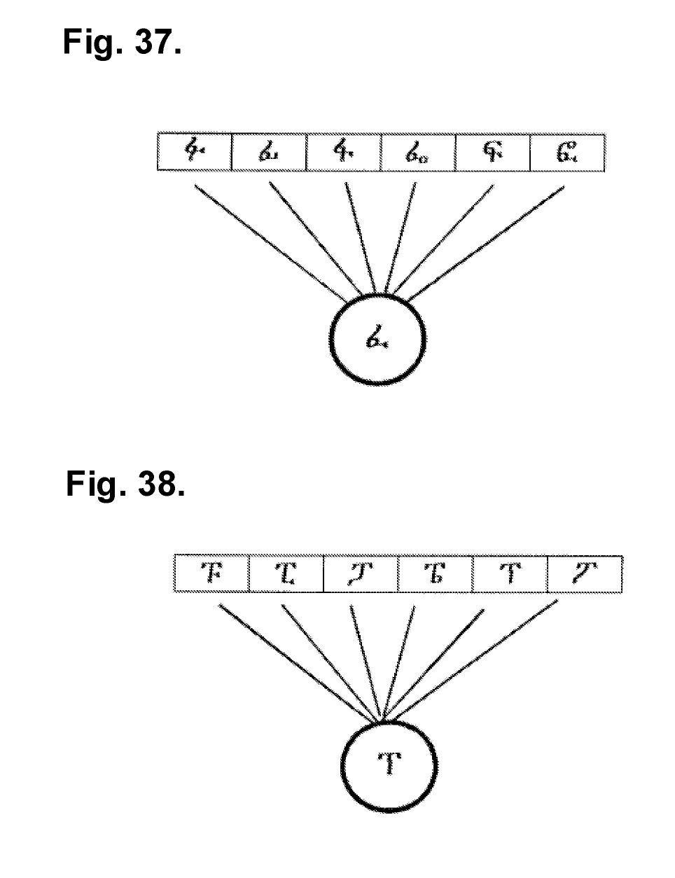

For example, FIGS. 6-38 are block diagrams showing, by way of example, combinations of a main letter with a sub-letter and the resulting letters based on the combinations. FIG. 6 is a block diagram showing, by way of example, a combination 60 of a main letter HA 62 with each of the sub-letters 61 of FIG. 4 to form extension letters 63. A main letter 62, for example, [symbol] (HA) can be selected and combined with each of the sub-letters 61, which activates six different extension letters 63 in the Amharic language. For example, a button for the HA main letter 62 is pressed, which can lock in the sub-letters 61 for the specific main letter 62 pressed until the button for another main letter is pressed or selected. Thus, upon pressing each of the sub-letters 61, the main letter HA 62 is combined with the sub-letter associated with the pressed button. The combinations for the main letter HA with each of the sub-letters 61 include the following extension or different letters 63: [symbol] (HU), [symbol] (HI), [symbol] (HA), [symbol] (HA'E') [symbol] (HE′) and [symbol] (HO). In lieu of locking the sub-letter 61 keys upon selection of a key for a main letter 62, each combination of main letter and sub-letter can be pressed separately.

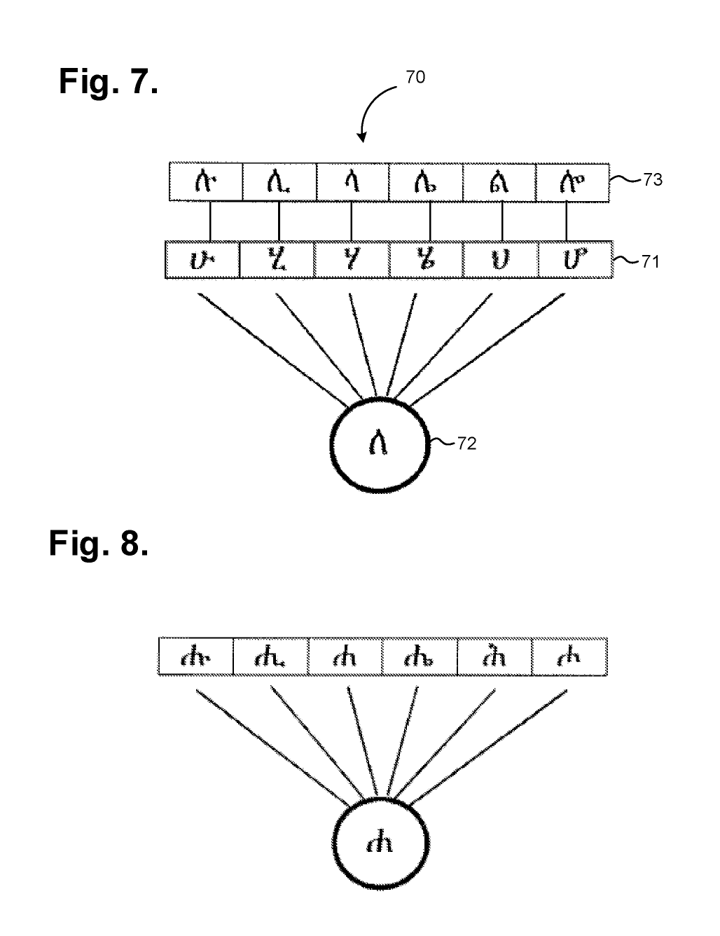

Also, FIG. 7 is a block diagram showing, by way of example, a combination 70 of a main letter LE' 72 with each of the sub-letters 71 of FIG. 4 to form extension letters 73. Upon selection of the main letter LE' 72, each of the sub-letters 71 can be selected to provide different extension letters 73 based on the consonant-vowel pairings of the main and sub-letters. A sound associated with the extension letter can be played, while the phonetic spelling of the sound can also be displayed. The letters and sounds for the extension letters associated with the combinations of the mail letter LE' with each of the sub-letters include [symbol] (LU), [symbol] (LI), [symbol] (LA), [symbol] (LAE), [symbol] (LE), and [symbol] (LO).

FIGS. 8-38 provide different extension letters formed from different combinations of main letter and sub-letter pairings. Each of the different letters formed by the pairings represents a consonant-vowel pairing. Other main letters and combinations with the sub-letters are possible for both the Amharic language, as well as different languages.

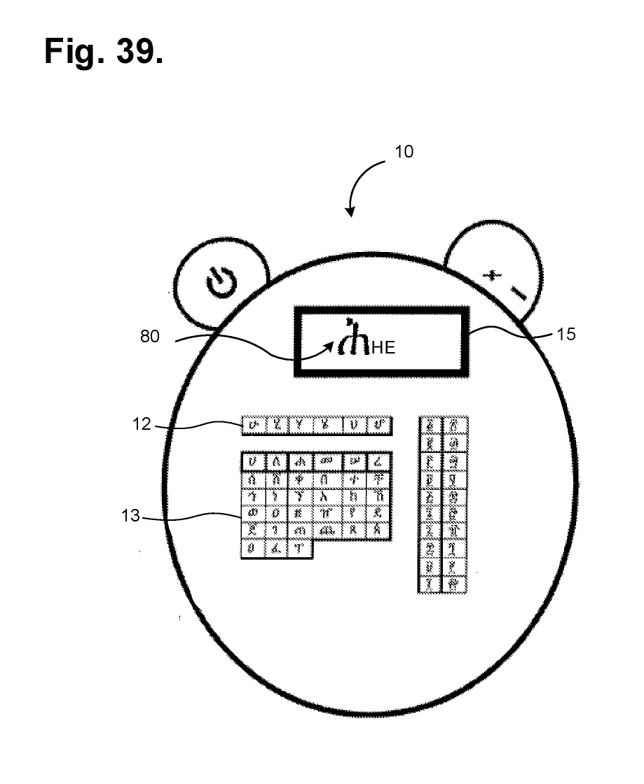

Accordingly, upon selection of one of the main letters and one of the sub-letters, the graphical representation of the letter represented by the main letter-sub-letter pair is displayed, while the sound associated with the displayed letter is played via a speaker. FIG. 39 is front view of the language learning device 10 of FIG. 1 with a graphical representation of a letter and written sound. The language learning device 10 includes a display 15 that can display a graphical representation 80 of a letter and an English version of the sound 80 associated with the letter. The letter can be chosen by selecting one of the main letters 13 and one of the sub-letters 12 that correspond with the displayed letter or by selecting one of the main letters itself. Prior to, simultaneously to, or after the display of the letter, the sound associated with the letter can be played via a speaker on the language learning device 10. The display can be an LED screen or other type of display.

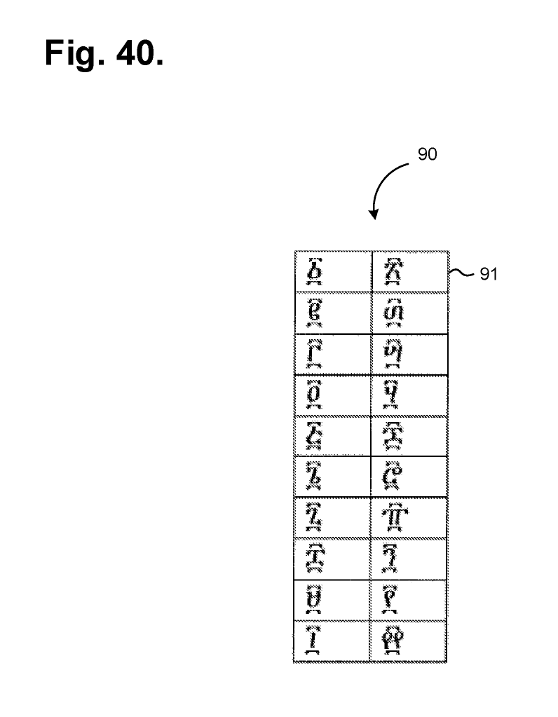

Numbers can also be provided via the language learning device. FIG. 40 is a block diagram showing, by way of example, buttons 91 for a set 90 of numbers 91. The set of numbers can include 20 numbers, including 1, 2, 3, 4, 5, 6, 7, 8, 9, 10, 20, 30, 40, 50, 60, 70, 80, 90, 100, and 1000. In one embodiment, numbers 1-10 can be listed on a right side of the device, while numbers 20-100 can be listed on a left side, or vice versa. However, other presentations of the numbers are possible, including providing no numbers on the language learning device.

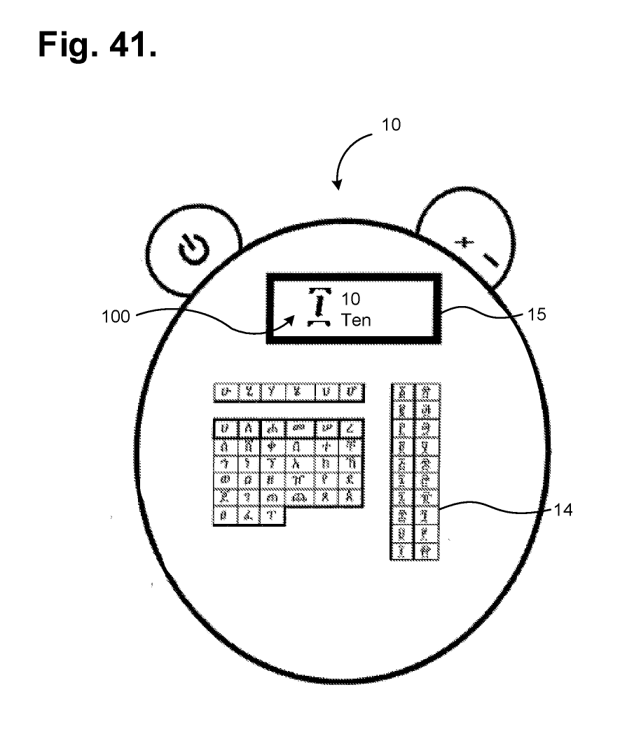

Pressing each number key can display the associated number. FIG. 41 is front view of the language learning device 10 of FIG. 1 with a graphical representation 100 of a number. The language learning device 10 can include a display 15 to display the graphical representation 100 of a number. The display 15 can also provide one or more of a corresponding Arabic number and English name for the number. Other types of information can also be displayed, such as Roman numbers or the name of the number in different languages. Further, the sound associated with pronouncing the number can be played. The number can be selected by pressing one or more of the number keys in the set 14. For example, the 30 key and the 1 key can be selected for the number 31.

Although the language learning device has been described above with respect to the Amharic language, the language learning device can include other languages, such as Japanese or German.

While the invention has been particularly shown and described as referenced to the embodiments thereof, those skilled in the art will understand that the foregoing and other changes in form and detail may be made therein without departing from the spirit and scope of the invention.

What is claimed is:

1. A language learning device, comprising:
a housing comprising data storage and a processor;
a first set of keys positioned on a front surface of the housing for sub-letters of a language;
a second set of keys positioned on the front surface of the housing for main letters of the language;
a display provided on the front surface of the housing to display a graphical representation of a letter identified by selection of one of the keys from the first set and one of the keys from the second set.

2. A language learning device according to claim 1, comprising:
a speaker provided on the housing.

3. A language learning device according to claim 1, wherein the speaker plays a recording of a sound associated with the letter displayed.

4. A language learning device according to claim 1, wherein a combination of each sub-letter with each main letter represents a different letter comprised of a consonant-vowel pairing.

5. A language learning device according to claim 1, wherein each sub-letter represents a vowel.

6. A language learning device according to claim 1, wherein each main letter represents a consonant.

7. A language learning device according to claim 1, comprising:
a headphone plugin provided on the housing.

8. A language learning device according to claim 1, comprising:
a third set of keys provided on the housing, each key in the third set representing a number.

9. A language learning device according to claim 1, wherein the selection of the key from the second set locks the keys of the first set for use with the selected key from the second set.

10. A language learning device according to claim 9, wherein selection of a different key from the second set releases the keys of the first set from use with the selected key and locks the keys of the first set for use with the different key selected.

11. A method for constructing a language learning device, comprising:
providing a housing comprising data storage and a processor;
positioning a first set of keys on a front surface of the housing for sub-letters of a language;
affixing a second set of keys on the front surface of the housing for main letters of the language;
affixing a display on the front surface of the housing to display a graphical representation of a letter identified by selection of one of the keys from the first set and one of the keys from the second set.

12. A method according to claim 11, comprising:
positioning a speaker on the housing.

13. A method according to claim 11, wherein the speaker plays a recording of a sound associated with the letter displayed.

14. A method according to claim 11, wherein a combination of each sub-letter with each main letter represents a different letter comprised of a consonant-vowel pairing.

15. A method according to claim 11, wherein each sub-letter represents a vowel.

16. A method according to claim 11, wherein each main letter represents a consonant.

17. A method according to claim 11, comprising:
affixing a headphone plugin on the housing.

18. A method according to claim 11, comprising:
affixing a third set of keys on the front surface of the housing, each key in the third set representing a number.

19. A method according to claim 11, wherein the selection of the key from the second set locks the keys of the first set for use with the selected key from the second set.

20. A method according to claim 19, wherein selection of a different key from the second set releases the keys of the first set from use with the selected key and locks the keys of the first set for use with the different key selected.
